(19) United States
(12) Patent Application Publication
(10) Pub. No.: US 2021/0122433 A1
(43) Pub. Date: Apr. 29, 2021

(54) ACTIVE APPARATUS HAVING A DIRECT DRIVE FOR MODIFYING AERODYNAMIC PROPERTIES OF A VEHICLE

(71) Applicant: Röchling Automotive SE & Co. KG, Mannheim (DE)

(72) Inventors: Domenico Solazzo, Worms (DE); Jürgen Schneider, Worms (DE)

(21) Appl. No.: 17/077,733

(22) Filed: Oct. 22, 2020

(30) Foreign Application Priority Data
Oct. 25, 2019 (DE) 10 2019 128 868.1

(51) Int. Cl. B62D 35/00; B62D 29/04; H02J 50/00

(52) U.S. Cl. CPC B62D 35/00; B60R 16/0231; H02J 50/001; B62D 29/043

(57) ABSTRACT

An active apparatus for modifying aerodynamic properties of a vehicle, encompassing: an apparatus frame; an air flap mounted pivotably on the apparatus frame; and an electric motor for bringing about a pivoting motion of the air flap, the electric motor being embodied as a direct drive for the air flap.

This Application claims priority in German Patent Application DE 10 2019 128 868.1 filed on Oct. 25, 2019, which is incorporated by reference herein.

The present invention relates to an apparatus for modifying aerodynamic properties of a vehicle.

### BACKGROUND OF THE INVENTION

In order to reduce the CO₂ emissions of vehicles, it is known to increase the efficiency of the vehicle propulsion system, and to reduce the air resistance by adapting aerodynamic properties of the vehicle in specific operating states of the vehicle, by means of pivotably mounted air flaps that are driven by an actuator, by the fact that the closed air flaps constitute a substantially flat flow impingement surface compared with other operating states in which the air flaps are opened, for instance in order to allow air flow to a heat exchanger.

The controllable actuator must be connected to a wiring system of the vehicle, however, in order to supply power and, if applicable, for data communication. An additional sensor is also required in order to furnish a reference for control application. Both of these aspects increase both the cost of the apparatus and the time required for installation of the apparatus.

With existing approaches, the actuators usually encompass a friction-affected reduction gearbox that is connected via a friction-affected linkage to the air flaps of the apparatus, so that the motor of the actuator is dimensioned to overcome the additional frictional losses that exist. Two separate arrays of air flaps, which are driven by a shared actuator utilizing toggle levers, are usually provided in a radiator grill. While the arrays of air flaps are arranged substantially mirror-symmetrically with respect to one another, a mirror-symmetrical arrangement of the toggle levers is often not possible. This results either in air flaps that are stiffened at all potential force engagement points (and are thus more expensive), or in a deformation of the air flaps.

An apparatus, embodied as a radiator grill having pivotable air flaps, for modifying aerodynamic properties of a vehicle, having a sensor arrangement for detecting the position of the air flaps, is shown in DE 10 2014 207 566 A1. Such apparatuses for modifying aerodynamic properties of vehicles are subject to a plurality of regulatory stipulations, conformity with which often requires a direct measurement of the angular position of the individual air flaps. The wiring of the sensors used for that purpose increases the cost, complexity, and weight of such apparatuses. In addition, the wiring of sensors mounted on movable air flaps is subject to recurring deformation, which can result in wire breakage. An “angular position” of an air flap is, in particular, an angular position of a first reference direction, defined on the air flap, with respect to a second reference direction defined on the apparatus frame, the first reference direction and the second reference direction preferably proceeding perpendicularly to a rotation axis of the air flap and intersecting in it.

### SUMMARY OF THE INVENTION

An object of the present invention is therefore to furnish a particularly simple apparatus for modifying aerodynamic properties of a vehicle. This object is achieved according to the present invention.

In particular, the object is achieved according to the present invention by an active apparatus for modifying aerodynamic properties of a vehicle, encompassing: an apparatus frame; an air flap mounted pivotably on the apparatus frame; and an electric motor for bringing about a pivoting motion of the air flap which can be a rotary motion; the electric motor being embodied as a direct drive for the air flap. In particular, the electric motor embodied as a direct drive constitutes an actuator of the air flaps. Thanks to the embodiment of the electric motor as a direct drive, friction-affected gearboxes and linkages are omitted, which simplifies the apparatus because of the smaller number of components and also makes it less fault-susceptible and more economical. In addition, no backlash of the gearbox or linkage needs to be taken into account when applying control to the electric motor, and the hysteresis angle when driving the air flap is correspondingly reduced. Furthermore, no frictional losses occur in a gearbox or linkage, so that the electric motor can be designed for lower torque. The omission of a gearbox and linkage moreover reduces the installation space necessary for the apparatus. The electric motor embodied as a direct drive can be a magnetic direct drive. The apparatus, in particular the electric motor itself, can encompass a regulation unit and/or control unit for regulating and/or controlling the electric motor, which unit is preferably furthermore respectively configured to communicate wirelessly, in particular directly or indirectly, with a communication module of the apparatus, in particular to receive control application instructions from the communication module of the apparatus. The communication module can be arranged on the apparatus frame or can be arranged in the vehicle remotely from the apparatus frame. The communication module can also be connected to a data bus of the vehicle. The air flap can be impinged upon by air blast while the vehicle is traveling. As a result of the pivoting motion of the air flap, its position in the air blast changes, and the air resistance of the vehicle changes as a result thereof.

A wireless connection or communication is a data connection or data communication that, for data transfer, proceeds at least in portions, preferably entirely, via WLAN, Bluetooth, ZigBee, or with the aid of another wireless and non-cable-based specification.

In a particularly preferred embodiment, the electric motor is configured to perform mechanical work in the form of a rotary motion around a motor rotation axis; and the electric motor is arranged on the apparatus frame in such a way that the motor rotation axis is embodied collinearly with a pivot axis or rotation axis of the air flap. This permits particularly simple coupling of the electric motor to the air flap. In addition, it is possible to infer the positional change of the air flap from the relative position of the stator and the rotor of the electric motor. This is particularly advantageous because, by way of an interaction between coils of the electromagnets and permanent magnets in the electric motor, which can be based on back magnetomotive force (BMMF) or back electromotive force (BMEF), the electric motor itself can supply information from which a change in the relative position of the stator with respect to the rotor can be inferred, for instance in the regulation unit and/or control unit for regulating and/or controlling the electric motor. The electric motor embodied as a direct drive can be a torque motor, internal-rotor and external-rotor types being appropriate here. If accurate position control is desired, the electric motor embodied as a direct drive can also be a stepping motor, embodiment of the stepping motor as a reluctance stepping motor being preferred because of the simplified construction.

In order to simplify the apparatus, a separate bearing system for the air flap can be omitted at least at one end of the air flap. For this, the pivot axis of the air flap can be defined by a shaft portion of the air flap, and the electric motor can encompass a bearing for the shaft portion which, in particular, is carried and/or braced and/or held by a housing of the electric motor. Utilization of a magnetic bearing is preferred in this context because of the accurate and wear-free positioning. Alternatively, a plain bearing can be provided, at least one of, preferably all of, whose sliding surfaces are embodied using an injection-molding process, for example embodied by overmolding. A layer of injection-molded material embodied by such overmolding can protect that part or portion of the electric motor which is located below it, for instance a rotor portion or stator portion, from corrosion. In this Application, an injection-molding material can be a thermoplastic.

The air flap of the apparatus is preferably embodied using an injection-molding process. It is correspondingly preferred that a connection, configured for transferring the rotary motion, between a rotor of the electric motor and the air flap be embodied using an injection-molding process, so that the connection can be configured in stable and economical fashion.

It is preferred that the electric motor encompass an inner rotation portion and an outer rotation portion that are provided rotatably relative to one another, one portion from among the inner rotation portion and the outer rotation portion encompassing or constituting the rotor of the electric motor, and the other portion from among the inner rotation portion and the outer rotation portion encompassing or constituting a stator of the electric motor; the inner rotation portion encompassing an opening; and an injection-molding material, which preferably connects the inner rotation portion to the apparatus frame or to the air flap, abutting against an inner wall of the opening. This injection-molding material can fill the opening at least in part, particularly preferably can fill more than 30% of the volume of the opening, in particular can fill it substantially completely. A particularly strong and reliable connection is thereby constituted between the inner rotation portion, in particular when the electric motor is an internal-rotor motor, and the air flap or, in particular when the electric motor is an external-rotor motor, the apparatus frame. In order to increase the strength of the connection, the opening can encompass an opening, embodied in a direction transverse to the motor rotation axis (hereinafter referred to as a “transverse opening”), which is embodied in particular as a passthrough opening, and/or an opening, embodied in a direction parallel to the motor rotation axis (hereinafter referred to as an “axial opening”), which is embodied in particular as a passthrough opening. It is preferred in this context that a cavity of the transverse opening be in fluid communication with a cavity of the axial opening, in particular that it transition thereinto, so that particularly strong anchoring of the inner rotation portion in the injection-molding material is effected. In order to increase the strength of the anchoring, the injection-molding material can constitute a continuous element that can extend along an inner wall of the transverse opening and along an inner wall of the axial opening and, particularly preferably, transitions from the transverse opening into the axial opening.

In order to protect the inner rotation portion from corrosion, a wall of the inner rotation portion which faces toward the outer rotation portion can be coated with the injection-molding material or with a plastic, in particular with a further injection-molding material. It is thereby also possible to constitute a sliding surface of a plain bearing that acts between the outer rotation portion and the inner rotation portion.

In order also to anchor the outer rotation portion securely and inexpensively, it is preferred that the outer rotation portion be embedded in an injection-molding material for mounting in the apparatus frame (this being preferred when the electric motor is embodied as an internal-rotor motor) or in the air flap (this being preferred when the electric motor is embodied as an external-rotor motor) and/or be injection-applied onto the apparatus frame or on the air flap with the injection-molding material, and/or be mounted by overmolding with the injection-molding material. With this arrangement, the energized part of the motor can be furnished on the apparatus frame, which offers sufficient installation space for providing a supply of energy to the electric motor; the advantage also applies, mutatis mutandis, to the aforementioned anchoring of the inner rotation portion.

In order to protect the outer rotation portion from corrosion, a wall of the outer rotation portion which faces toward the inner rotation portion can be coated with the injection-molding material or with a plastic, in particular with a further injection-molding material. It is thereby also possible to constitute a further sliding surface of the aforementioned plain bearing that acts between the outer rotation portion and the inner rotation portion.

In order to permit an inspection of the operating state of the vehicle, the apparatus can encompass a sensor and/or a rotary encoder for determining an angular position of the air flap around a pivot axis, the electric motor particularly preferably also being embodied as a servomotor. The sensor and/or the rotary encoder can be a Hall effect sensor, an incremental encoder, a rotary variable differential transformer (RVDT), a potentiometer encoder, or an absolute encoder. It is also possible in particular however, to arrange a displacement sensor or position sensor on the air flap, preferably to injection-apply or overmold it or embed it into a material of the air flap. A capacitive distance sensor or a sensor based on a time-of-flight measurement is suitable in particular as a displacement sensor or position sensor in this context. The sensor and/or the rotary encoder can have associated with it a wireless data transfer unit that is configured in particular to transmit, via radio waves, measured data of the sensor and/or of the rotary encoder to a communication module of the apparatus. The sensor and/or the rotary encoder can be embodied, together with a data transfer unit, as a preferably encapsulated unit. An embodiment of the sensor and/or of the rotary encoder as a passive or active RFID sensor is particularly appropriate in this context. The data transfer unit can encompass a radio frequency antenna. The communication module can be embodied as part of a regulation unit and/or control unit.

The sensor and/or the rotary encoder, or also parts thereof, and/or the data transfer unit and/or the radio frequency antenna, can be arranged on the apparatus frame and/or on the air flap, in particular can be injection-applied using injection-molding material or overmolded with injection-molding material. In particular, the functional principle of the sensor and/or of the rotary encoder can be based on a noncontact measurement method, for example measurement of a magnetic field.

In order to reduce the weight occasioned by a wiring system, and the wiring complexity associated with wiring, it is preferred that the sensor and/or the rotary encoder be configured to transfer measured data detected by them in wireless fashion, in particular directly or indirectly, to a communication module of the apparatus and/or to a control apparatus of the apparatus and/or to a regulation apparatus of the apparatus and/or to a vehicle evaluation unit, which are respectively configured to receive those measured data. If the signal output of the sensor and/or of the rotary encoder is not arranged in stationary fashion with respect to the apparatus frame, for instance arranged on the air flap, the problem of the occurrence of signal interruptions due to wire breakages in signal leads at repeatedly bent wire portions is thereby also solved.

In order also to solve, for the wiring that supplies energy to components of the apparatus, the problems described for the signal leads, the apparatus can furthermore encompass a receiving apparatus for receiving wirelessly transferred energy, in particular a power receiving part of a wireless power transfer apparatus and/or an energy harvesting apparatus, respectively for supplying energy to the electric motor and/or to a sensor and/or to a rotary encoder and/or to a control apparatus and/or regulation apparatus.

In a particularly preferred embodiment, the apparatus is configured to transfer data representing an angular position of the air flap, using a vehicle data bus, to a vehicle evaluation unit, in order to permit the vehicle to diagnosis the status of the apparatus.

The apparatus preferably encompasses a control unit and/or regulation unit that is configured to regulate and/or control the electric motor. The control unit and/or regulation unit can also be configured to receive signals and/or data from the sensor and/or the rotary encoder.

The one air flap described in detail above will be referred to hereinafter as a “drive air flap.” The apparatus preferably encompasses at least one, preferably several, further air flaps that are arranged pivotably on the apparatus frame.

The drive air flap is preferably connected, using a linkage, to at least one, preferably a plurality of, further air flaps in such a way that a transfer of the drive air flap from a closed position into an opened position brings about a transfer of further air flaps, connected to the linkage, from a closed position into an opened position of those further air flaps; and that a converse transfer of the drive air flap from the opened position into the closed position brings about a transfer of further air flaps, connected to the linkage, from the opened position into the closed position of those further air flaps.

The angular position of each of the further air flaps connected to the linkage is preferably unequivocally determined via a connection to the linkage, so that the angular position of the drive air flap can be used as a basis for determining the angular position of each of the further air flaps connected to the linkage.

In a particular preferred embodiment, however, in order to prevent errors in determining the position of the further air flaps based on the position of the drive air flap which can be caused, for instance, by broken connections between the linkage and one of the air flaps, the apparatus can encompass for each further air flap a respective sensor and/or rotary encoder for determining the angular position of the respective further air flaps, such that the types of sensors and rotary encoders recited for the drive air flap can also be used for the further air flaps.

The apparatus can furthermore also, via the wireless power transfer apparatus and/or an energy harvesting apparatus, supply energy to at least one, preferably each, of the sensors and/or rotary encoders for determining the angular position of the respective further air flap. Additionally or alternatively, the apparatus can furthermore encompass a respective wireless power transfer apparatus and/or an energy harvesting apparatus for supplying energy to a sensor and/or rotary encoder associated with a further air flap.

In a particularly preferred embodiment, the wireless power transfer apparatus and/or the energy harvesting apparatus encompasses a respective power transmission part configured to emit a power-transferring electromagnetic wave, and a respective power receiving part configured to receive the electromagnetic wave emitted by the power transmitting part and to furnish energy for a load. The power receiving part can be arranged on the apparatus frame, and the power transmitting part can be arranged remotely from the apparatus frame, for instance on the vehicle.

In a particularly preferred embodiment of the invention, the electric motor and/or a/the sensor and/or rotary encoder and/or a/the power receiving part of the wireless power transfer apparatus and/or a/the power receiving part of the energy harvesting apparatus and/or a/the power transmitting part of the wireless power transfer apparatus and/or a/the power transmitting part of the energy harvesting apparatus is provided as a unit that is configured to be placed into an injection mold and, in that injection mold during the injection-molding process, to be injection-applied or overmolded or embedded into injection-molding material as part of the apparatus. This can be accomplished in a single-stage or multi-stage injection-molding process.

Optionally, the air flaps and the apparatus frame can be embodied separately from one another in a respective injection-molding process, and then assembled to one another. In that context, the aforementioned parts in units respectively associated with the air flap or the apparatus frame to be constituted can be placed into the respective injection molds. It is to be noted in this context that, in particular, the inner rotation portion and the outer rotation portion in different associated units can be placed into the respective separate injection molds.

In a particularly preferred embodiment, the apparatus furthermore encompasses a regulation unit and/or control unit for regulating and/or controlling the electric motor. It is preferred that the power receiving part of the wireless power transfer apparatus and/or the power receiving part of the energy harvesting apparatus be connected to the regulation unit and/or control unit for regulating and/or controlling the electric motor, and be configured for data exchange with the power transmitting part of the wireless power transfer apparatus and/or with the power transmitting part of the energy harvesting apparatus, the power transfer apparatus and/or the energy harvesting apparatus in particular being configured to transfer motor control application signals from the respective power transmitting part to the respective power receiving part, and to transfer the angular position of one, or a plurality, preferably all, of the air flaps to the power transmitting part. The power transmitting part can also additionally be embodied as the above-described communication module.

Actuators and/or regulation units and/or control units can transfer power and data to light-emitting diodes and/or to light-emitting diode circuits.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 is a view of an embodiment of the apparatus according to the present invention, having two drive air flaps and associated further air flaps, in the opened position;

FIG. 2 is a view of the embodiment of FIG. 1 with the two drive air flaps and the associated further air flaps, in the closed position;

FIG. 3 shows a portion of a view from above (in a Z direction) of the embodiment of FIG. 1;

FIG. 4 shows a portion of an A-A section from FIG. 3;

FIG. 5 shows a further air flap of the embodiment of FIG. 1;

FIG. 6 shows an optional embodiment of a further air flap of the embodiment of FIG. 1;

FIG. 7 shows a drive air flap of the embodiment of FIG. 1; and

FIGS. 8 and 9 show optional embodiments of a drive air flap of the embodiment of FIG. 1.

In order to increase the clarity of the Figures, reference characters are not repeated in some Figures.

It is expressly noted that the Figures for the present Application are not accurately to scale, nor are they accurate depictions in terms of a relative motion of moving elements. The Figures serve merely to illustrate the principle of the present invention, and are correspondingly schematic in nature.

### DESCRIPTION OF PREFERRED EMBODIMENTS

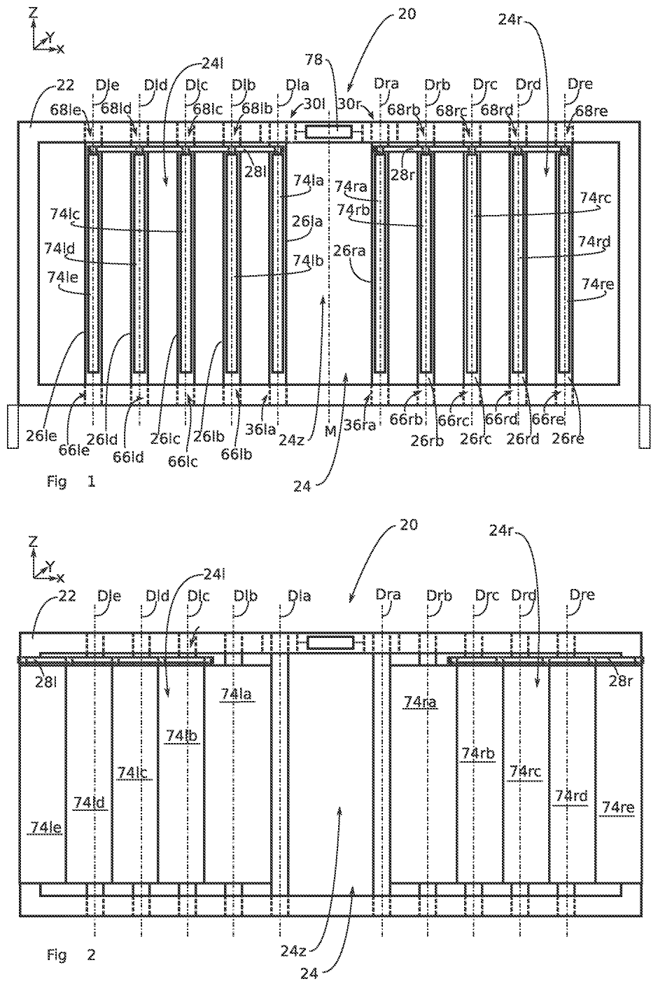

Referring now to the drawings wherein the showings are for the purpose of illustrating preferred and alternative embodiments of the invention only and not for the purpose of limiting the same, FIGS. 1 and 2 show an embodiment according to the present invention of an apparatus, embodied as an air flap apparatus 20, for modifying aerodynamic properties of a vehicle in which the apparatus is installed. FIG. 1 shows a state of air flap apparatus 20 in which air flaps 26la to 26le and 26ra to 26re are in the opened position, and FIG. 2 shows a state of air flap apparatus 20 in which air flaps 26la to 26le; 26ra, 26re are in a closed position. Air flap apparatus 20 encompasses an apparatus frame 22 that is arranged preferably in stationary fashion with respect to a chassis portion or frame portion of the vehicle. Air flap apparatus 20 can be part of a radiator grill of the vehicle which is arranged, in particular at the front in a forward direction, on an outer side of the vehicle impinged upon by the flow of an air blast. Formation of a flatter flow impingement surface in the closed position causes a change in the air resistance of the vehicle as compared with the state in which the air flaps are in the opened position.

Apparatus frame 22 comprises a flowthrough opening 24 that encompasses, preferably is constituted by, two flowthrough sub-openings 24l and 24r and an intermediate region 24z located between flowthrough sub-openings 24l and 24r. Actuators, sensors, and the like can be arranged in intermediate region 24z; in particular, this intermediate region 24z is usually covered by a body portion of the vehicle which carries a vehicle emblem.

Because the configuration of apparatus 22 is embodied substantially mirror-symmetrically with respect to a plane of symmetry M that passes perpendicularly through the drawing plane of FIGS. 1 and 2, the description hereinafter is limited to the left passthrough sub-opening 24l and to air flaps 26la to 26le arranged therein and the elements and parts of apparatus 20 interacting therewith. The corresponding reflected right-hand elements are labeled with the index “r” so that, for instance, air flaps 26ra to 26re that are arranged in mirror-image fashion with respect to air flaps 26la to 26le in terms of plane M are provided in flowthrough sub-opening 24r. The description of the left side of apparatus 20 is to be applied correspondingly to the right-hand flowthrough sub-opening 24r and to air flaps 26ra to 26re arranged therein and the elements and parts of apparatus 20 interacting therewith, unless otherwise indicated by the description. Reference characters of elements, parts, portions, or geometric representations such as rotation axes, which correspond to one another in the context of air flaps 26la to 26le or of the mounting thereof, have the same value, for instance the reference character of rotation axis Dl discussed below, but are not equipped with a serial index from a to e or b to e, and only one element, portion, or geometric representation is described in detail; that description is also to be applied to the other elements, portions, or geometric representations having the same value of the reference character but a different serial index.

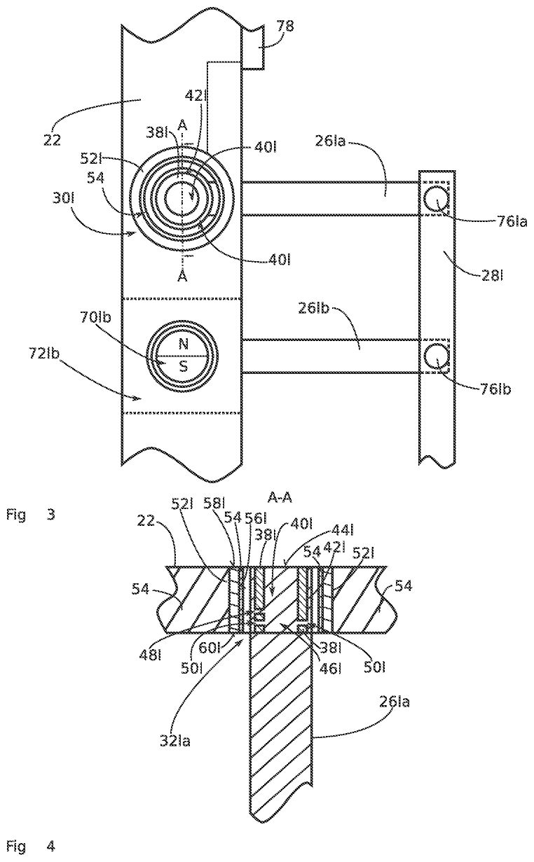

Looking in a direction that is orthogonal to the drawing plane of FIGS. 1 and 2 that passes through the respective passthrough sub-opening 24l, a plurality of air flaps 26la to 26le are positioned on apparatus frame 22 rotatably on rotation axes Dla to Dle. Air flap 26la shown in FIG. 7 is embodied as a drive air flap, and air flaps 26lb to 26le each constitute preferably identically embodied further air flaps as shown in FIG. 5. Drive air flap 26la is connected via a drive rod 28l to the associated further air flaps 26lb to 26le for motion together. An electric motor 30l embodied as a direct drive is provided between apparatus frame 22 and drive air flap 26la in order to bring about a pivoting motion of drive air flap 26la. Electric motor 30l, depicted particularly well in FIGS. 3 and 4, is preferably a torque motor whose rotation axis coincides collinearly with rotation axis Dla of drive air flap 26la. Rotation axis Dla of drive air flap 26la is defined in particular by a central line of collinear and mutually oppositely located shaft portions 32la, 34la of drive air flap 26la. Shaft portion 34la is preferably mounted rotatably in a plain bearing 36la embodied in apparatus frame 22, while a rotor 38l of electric motor 30l, embodying an inner rotation portion of electric motor 30l, is anchored nonrotatably in shaft portion 32la by overmolding with injection-molding material 40l; in particular, an outer surface 42l, facing toward a stator to be described later, of a wall of rotor 38l is overmolded with injection-molding material 401 in order to protect rotor 38l from corrosion, and thus constitutes a protective layer. A layer of this kind can also be provided on end face 44l of shaft portion 32la in order to protect rotor 38l from corrosion. A first axial passthrough opening 46l, which is completely filled with injection-molding material 40l and extends along the motor rotation axis, coinciding with rotation axis Dla, of electric motor 30l, is preferably provided in rotor 38l. Two transverse passthrough openings 48l, 50l, whose cavities transition into the cavity of axial passthrough opening 46l and are likewise completely filled with injection-molding material 40l and which proceed, in the exemplifying embodiment, perpendicularly to rotation axis Dla, also extend through rotor 38l. Particularly strong anchoring of rotor 38l to drive air flap 26la is produced by the resulting material bridge between each of transverse passthrough openings 48l, 50l and axial passthrough opening 46l. Injection-molding material 40l abuts in particular against the respective inner walls of transverse passthrough openings 48l, 50l and of axial passthrough opening 46l.

Electric motor 30l further encompasses a stator 52l, which surrounds rotor 38l and constitutes an outer rotation portion of electric motor 30l. Rotor 38l preferably encompasses a permanent-magnet arrangement, and stator 52l preferably encompasses an electromagnet arrangement for driving electric motor 30l. In addition, by way of a suitable arrangement of permanent magnets and/or electromagnets of electric motor 301 in the inner rotation portion and outer rotation portion, a magnetic bearing can be provided between inner rotation portion and outer rotation portion, which bearing is also a bearing of shaft portion 32la and braces against a housing of electric motor 30l via the outer rotation portion. If a so-called “housingless” electric motor is used, the apparatus frame is to be regarded as a housing of the electric motor. Alternatively, electric motor 30l can encompass a plain bearing that is likewise braced via the outer rotation portion and also supports shaft portion 32la.

Stator 52l is overmolded with injection-molding material 54 of apparatus frame 22 and thereby arranged nonrotatably thereon. Stator 52l can also be coated with injection-molding material 54 for corrosion protection on its surface 56l, facing toward rotor 38l, of its wall. A coating of this kind can likewise be provided for corrosion protection on axial end surfaces 58l, 60l of stator 52l. A Hall sensor, e.g. a Hall sensor having a plurality of physically separated measurement fields (e.g. quadrants), for determining an angular position of the permanent-magnet arrangement of the rotor, and thus of the rotor itself, relative to the stator, can be provided in stator 52l. Alternatively and/or additionally, a voltage produced in the windings of the electromagnets of the stator by the motion of the permanent-magnet arrangement of the rotor, in particular as a result of a back magnetomotive force (BMMF) or back electromotive force (BMEF), or a current produced therein, can be detected and can be used to determine the position of the permanent-magnet arrangement of the rotor and thus of the rotor itself. Particularly preferably, electric motor 30l is embodied as a servomotor, so that separate detection of the position of the rotor is not necessary. Because rotor 52l is connected nonrotatably to apparatus frame 22 and rotor 38l is connected nonrotatably to drive air flap 26la, in all these variants an angular position of the drive air flap relative to apparatus frame 22 is thus detected.

Further air flaps 26lb to 26le are preferably embodied, mounted on apparatus frame 22, and equipped with sensors, identically to one another. Air flap 26lb is mounted pivotably around its rotation axis Dlb on shaft portions 62la and 64la in associated counterpart bearings 66lb and 68lb in apparatus frame 22. A magnet arrangement 70la, having a north pole N and a south pole S and connected nonrotatably to shaft portion 62la, is preferably provided on that shaft portion, so that the angular position of magnet arrangement 70la relative to apparatus frame 22, and thus the angular position of air flap 26lb relative to apparatus frame 22, can be detected by means of a Hall sensor 72lb, e.g. a Hall sensor having four quadrants, arranged in stationary fashion with respect to apparatus frame 22. The position of the magnet arrangements of further air flaps 26c to 26e, and thus the angular position of those individual air flaps relative to apparatus frame 22, can correspondingly be detected by way of Hall sensors (not shown) that are associated with the respective individual air flaps and are arranged in stationary fashion with respect to apparatus frame 22. Note that in order to maintain clarity, the Hall sensors have not been depicted in FIGS. 1 and 2.

Drive air flap 26la comprises at one end of its air flap blade 74la a mandrel 76la which extends parallel to rotation axis Dla of drive air flap 26la and which engages into drive rod 28l and is mounted rotatably in drive rod 28l in a bearing. Further air flap 26lb, which is embodied identically to further air flaps 26lc to 26le, furthermore likewise comprises a mandrel 76lb which extends parallel to rotation axis Dlb of further air flap 26lb and which likewise engages into drive rod 28l and is mounted rotatably in drive rod 28l in a bearing. The mandrels of further air flaps 26lc to 26le engage similarly into similar bearings in drive rod 28l, so that a pivoting of drive air flap 26la likewise results in a corresponding pivoting of all further air flaps 26lb to 26le. Drive air flap 26la and/or further air flaps 26lc are preferably embodied, using an injection-molding process, in such a way that air flap blade 74la, shaft portions 32la, 34la, and mandrel 76la are embodied continuously, preferably integrally. The same applies correspondingly to air flap blade 74lb, to shaft portions 62lb, 64lb, and to mandrel 76lb.

Electric motor 30l is preferably embodied with a power receiving part 78 of a wireless power transfer apparatus of apparatus 20. The wireless power transfer apparatus encompasses a power transmitting part (not illustrated) that is arranged on the vehicle. The wireless power transfer apparatus is furthermore configured to permit a data transfer in both directions between power receiving part 78 and the power transmitting part. The power transmitting part communicates via a transceiver with a data bus, e.g. a CAN bus, of the vehicle, which in turn communicates with a vehicle evaluation unit, e.g. an ECU, of the vehicle. Electric motor 30l is preferably embodied with a control unit and regulation unit which is connected in terms of data technology, in wire-based or wireless fashion, to power receiving part 78 in order to receive control instructions of the vehicle via the data bus and the wireless power transfer apparatus. Power receiving part 78 is an embodiment of a communication module of apparatus 20.

Each of the Hall sensors, or sensors for detecting the respective angular position, which is associated with drive air flap 26la and with further air flaps 26lb to 26le is preferably also configured to communicate wirelessly with power receiving part 78 and to transfer to the vehicle, via the wireless power transfer apparatus and the data bus, the respective angular position of the associated drive air flap 26la and/or of each of further air flaps 26lb to 26le, so that those angular positions are available, for example, to an OBD1/OBD2 diagnostic system.

Power receiving part 78 can also furnish the aforesaid functions for electric motor 30r and for the Hall sensors, or sensors for detecting the respective angular position, associated with air flaps 26ra to 26re.

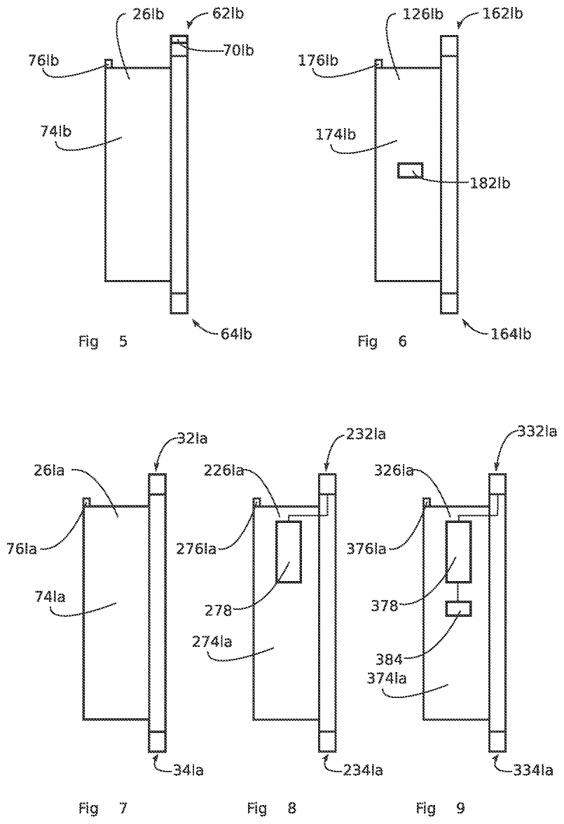

FIG. 6 shows an optional embodiment of the further air flap of apparatus 20, only the differences with respect to further air flaps 26lb to 26le being discussed below. Reference characters incremented by 100 are used for the elements, sub-portions, etc. of this optional embodiment which correspond to those of the embodiment described above, reference being made, with regard to those elements, sub-portions, etc., to the description of the corresponding elements of the embodiment described above. The further reference characters of apparatus 20, as well as axis designations, remain those of the embodiment described above.

The same is correspondingly the case for the optional embodiment of the drive air flap shown in FIG. 8, reference characters incremented by 200 being used for the elements, sub-portions, etc. of this optional embodiment which correspond to those of the embodiment described above. In the optional embodiment of the drive air flap shown in FIG. 9, reference characters incremented by 300 are analogously used for the elements, sub-portions, etc. corresponding to those of the embodiment described above.

Further air flap 126lb, preferably identical in design to all further air flaps, differs from further air flap 26lb in that instead of the magnet arrangement for detection by way of Hall sensor 72lb in air flap 126lb, an RFID position sensor 182lb is provided which is configured to determine the angular position of further air flap 126lb relative to apparatus frame 22 and to transfer it wirelessly to power receiving part 78, which can have the function of an RFID reading device. When a further air flap 126lb of this kind is provided, provision of the associated Hall sensor on apparatus frame 22 can be dispensed with.

The embodiment of drive air flap 226la shown in FIG. 8 is provided for use in an apparatus 20 in which the outer rotation portion encompasses an arrangement of permanent magnets, and the inner rotation portion encompasses an arrangement of electromagnets.

A power receiving part 278 is correspondingly provided on an air flap blade 274la of drive air flap 226la in order to supply energy to the arrangements of electromagnets in the inner rotation portion.

The embodiment of drive air flap 326la shown in FIG. 9 differs from drive air flap 226la in that an RFID position sensor 384, which is preferably embodied as an active RFID sensor and is preferably supplied with energy from power receiving part 378, is provided for determining the angular position of drive air flap 326la relative to apparatus frame 22. RFID position sensor 384 is preferably configured to transfer the angular position wirelessly to power receiving part 78, which can have the function of an RFID reading device.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-12. (canceled)

13. An active apparatus for modifying aerodynamic properties of a vehicle, encompassing:
an apparatus frame;
an air flap mounted pivotably on the apparatus frame; and
an electric motor for bringing about a pivoting motion of the air flap, wherein the electric motor is embodied as a direct drive for the air flap.

14. The active apparatus according to claim 13, wherein the electric motor is configured to perform mechanical work in the form of a rotary motion around a motor rotation axis; and the electric motor is arranged on the apparatus frame in such a way that the motor rotation axis is embodied collinearly with a pivot axis of the air flap.

15. The active apparatus according to claim 14, wherein the pivot axis of the air flap is defined by a shaft portion of the air flap; and the electric motor encompasses a bearing for the shaft portion.

16. The active apparatus according to claim 15, wherein a connection, configured for transferring the rotary motion, between a rotor of the electric motor and the air flap is embodied using an injection-molding process.

17. The active apparatus according to claim 16, wherein the electric motor encompasses an inner rotation portion and an outer rotation portion that are provided rotatably relative to one another, one portion from among the inner rotation portion and the outer rotation portion encompassing or constituting the rotor of the electric motor, and the other portion from among the inner rotation portion and the outer rotation portion encompassing or constituting a stator of the electric motor; the inner rotation portion encompassing an opening; and an injection-molding material abutting against an inner wall of the opening.

18. The active apparatus according to claim 17, wherein a wall of the inner rotation portion which faces toward the outer rotation portion is coated with the injection-molding material (401) or with a plastic.

19. The active apparatus according to claim 17, wherein the outer rotation portion is embedded in an injection-molding material for mounting in the apparatus frame or in the air flap, and/or is injection-applied onto the apparatus frame or on the air flap with the injection-molding material or is mounted by overmolding with the injection-molding material.

20. The active apparatus according to claim 19, wherein a wall of the outer rotation portion which faces toward the inner rotation portion is coated with the injection-molding material or with a plastic.

21. The active apparatus according to claim 14, wherein a connection, configured for transferring the rotary motion, between a rotor of the electric motor and the air flap is embodied using an injection-molding process.

22. The active apparatus according to claim 2l, wherein the electric motor encompasses an inner rotation portion and an outer rotation portion that are provided rotatably relative to one another, one portion from among the inner rotation portion and the outer rotation portion encompassing or constituting the rotor of the electric motor, and the other portion from among the inner rotation portion and the outer rotation portion encompassing or constituting a stator of the electric motor; the inner rotation portion encompassing an opening; and an injection-molding material abutting against an inner wall of the opening.

23. The active apparatus according to claim 22, wherein a wall of the inner rotation portion which faces toward the outer rotation portion is coated with the injection-molding material (40l) or with a plastic.

24. The active apparatus according to claim 22, wherein the outer rotation portion is embedded in an injection-molding material for mounting in the apparatus frame or in the air flap, and/or is injection-applied onto the apparatus frame or on the air flap with the injection-molding material or is mounted by overmolding with the injection-molding material.

25. The active apparatus according to claim 24, wherein a wall of the outer rotation portion which faces toward the inner rotation portion is coated with the injection-molding material or with a plastic.

26. The active apparatus according to claim 13, wherein the apparatus encompasses at least one of a sensor and a rotary encoder for determining an angular position of the air flap around a pivot axis.

27. The active apparatus according to claim 26, wherein the at least one of the sensor and the rotary encoder are configured to transfer measured data detected by them, in wireless fashion, to at least one of a communication module of the apparatus, a control apparatus of the apparatus, a regulation apparatus of the apparatus and a vehicle evaluation unit, which are respectively configured to receive those measured data.

28. The active apparatus according to claim 27, further encompassing at least one of an energy harvesting apparatus and a receiving apparatus for receiving wirelessly transferred energy, for supplying energy to at least one of the electric motor, the sensor, the rotary encoder, the control apparatus and the regulation apparatus.

29. The active apparatus according to claim 13, further encompassing at least one of an energy harvesting apparatus and a receiving apparatus for receiving wirelessly transferred energy, for supplying energy to at least one of the electric motor, a sensor, a rotary encoder, a control apparatus and a regulation apparatus.

30. The active apparatus according to claim 13, wherein the apparatus is configured to transfer data representing an angular position of the air flap, using a vehicle data bus, to a vehicle evaluation unit.
